(19) United States
(12) Patent Application Publication
(10) Pub. No.: US 2024/0225948 A9
(43) Pub. Date: Jul. 11, 2024

(54) METHOD OF APPLYING WAVE THERAPY AND AN OCCUPANT PLATFORM FOR USE WITH SAME

(71) Applicant: Freedom Medical, Inc., Exton, PA (US)

(72) Inventor: Jeffrey Schmutz, New Hope, PA (US)

(21) Appl. No.: 17/969,429

(22) Filed: Oct. 19, 2022

(51) Int. Cl. A61H 9/00; A47C 7/46

(52) U.S. Cl. CPC A61H 9/0078; A47C 7/467; A61H 2201/5002; A61H 2201/5007

(57) ABSTRACT

The wave therapy method includes providing an occupant surface for accepting an occupant thereon and a control unit for holding a specific pressure, based on the weight of the occupant of the surface, for a preferred first preselected duration and continuously adjusting the pressure applied. Continuously adjusting the pressure comprises may include increasing the pressure by a preselected amount and holding this new pressure for a second preselected duration, decreasing the pressure by the preselected amount to return the surface to the original set low pressure, repeating the cycle one or more times.

### CROSS REFERENCE TO RELATED APPLICATIONS

This application also claims the benefit of U.S. Provisional Application No. 63/257,410, filed Oct. 19, 2021. The entire disclosure of which is incorporated herein by reference.

### STATEMENT REGARDING FEDERALLY

### Sponsored Research or Development

The present invention was not developed with the use of any Federal Funds, but was developed independently by the inventors.

### BACKGROUND

### Field

The invention relates to a wave therapy method and an occupant platform wherein a specific timing of fluid, such as air, passage to and from specific chambers within an air support surface, such as a mattress, is coupled with low air loss therapy.

### Summary

In the invention, fluid is dispensed into the surface at a specific pressure and is maintained for a specific duration of time. The pressure then is reduced by a preselected amount or percentage, and again held for a preferably longer preselected duration. This timing sequence of low pressure-pulsation, coupled with low air loss; provides wave therapy.

In one preferred form of the invention a method for applying wave therapy to an occupant surface is disclosed. The method includes providing a surface for accepting an occupant thereon and a control unit for providing a specific pressure, based on the weight of the occupant of the surface, for a preferred first preselected duration and continuously adjusting the pressure applied.

Continuously adjusting the pressure may include increasing the pressure by a preselected amount and holding this second pressure for a second preselected duration, decreasing the pressure by the preselected amount to return the surface to the original set low pressure, repeating the cycle one or more times. In one preferred form, the first preselected duration is about 90 seconds and the cycle one or more times, the preselected amount of pressure is 20%, and the second preselected duration is about 60 seconds. Preferably, the occupant surface comprises a pressurized plenum has a plurality of connected bladders or cells.

In another form of the invention, an auto set functionality is provided that delivers pressures from about 17 mmHg (low pressure duration) to about 22 mmHg (high pressure duration) or from about from about 24 mmHg (low pressure duration) to about 30 mmHg (high pressure duration).

In another form of the invention an occupant platform is provided having an occupant surface for accepting an occupant thereon; a control unit for selecting and setting a specific pressure, based on the weight and/or height, a function of Body Mass Index (BMI)), for the occupant of the surface, for a preferred first preselected duration; and continuously adjusting the pressure applied cells.

An air support surface, sometimes referred to as a “Low Air Loss” surface comprises various materials ranging in permeability. The surface features a plurality of chambers designed to fill with fluid, such as air, at preselected pressures and timings. The timing of fluid passing into and through these chambers is electronically controlled with an external electronic device, hereinafter referred to as the “control unit.” This control unit is responsible for the inflation and timing of various fluid inputs of the surface. A specific timing sequence has been specified to provide therapeutic benefit and reduce the incidence of acquired pressure injuries resulting from immobility. Clinical studies have shown that reducing pressures on bed-bound persons, along with routine turning and repositioning greatly reduce the onset and incidence of acquired pressure injuries.

It is an object of the present invention to provide a device and method of use that reduces pressures on bed-bound persons to greatly reduce the onset and incidence of acquired pressure injuries and the treatment of existing injuries.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is a perspective view of an exemplary occupant platform including an occupant support positioned thereon in accordance the present invention shown.

FIG. 2 is an exploded assembly view of the occupant support of FIG. 1 showing the patient support including a base and a plurality of turn bladders, positioned under the base.

FIG. 3 is a perspective view showing an underside of the occupant support of FIG. 1.

FIG. 4 is a view of a schematic view of an occupant support surface with wave therapy being applied in accordance with the present invention.

FIG. 5 is a view of a schematic view of an occupant lying on the occupant support surface with wave therapy being applied in accordance with the present invention.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

The embodiments disclosed herein are not intended to be exhaustive or to limit the invention to the precise forms disclosed in the following detailed description. Rather, the embodiments are chosen and described so that others skilled in the art may utilize their teachings.

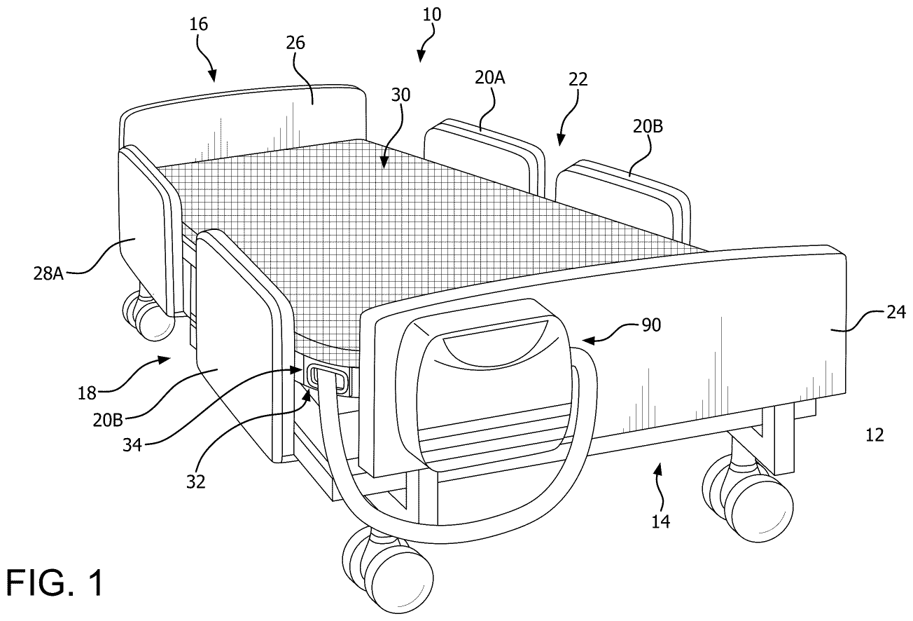

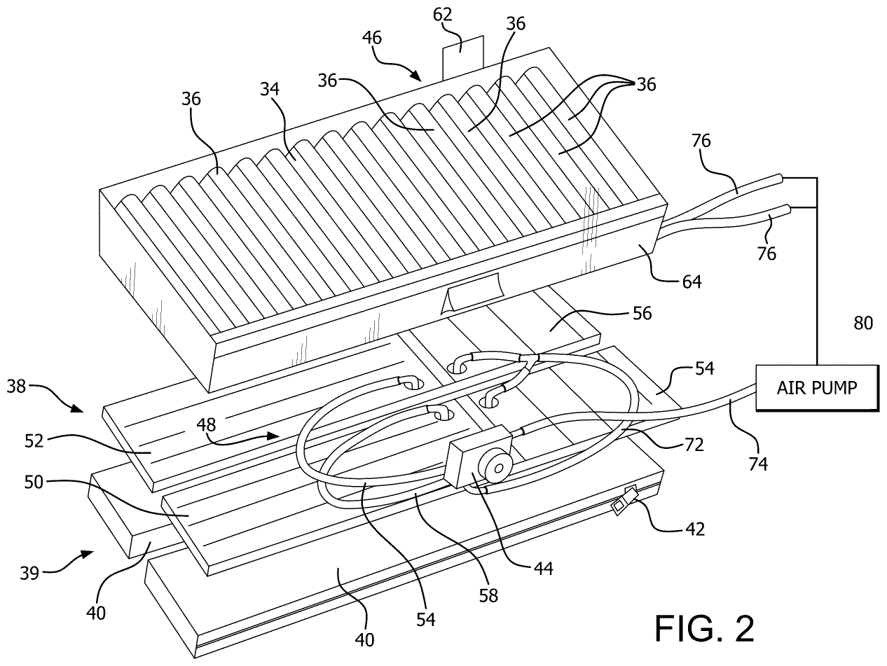

Referring to FIG. 1, an exemplary occupant support 10, exemplified by a hospital bed, is shown. The occupant support 10 includes a base frame 12. The base frame 12 includes a foot end 14, a head end 16, a first side 18 and a second side 22. A footboard 24 is positioned at the foot end 14 of the base frame 12. A headboard 26 is positioned at the head end 16 of the base frame 12. A plurality of side barriers 28A and 28B are positioned along the first side 18 of the base frame 12. A plurality of side barriers 20A and 20B are positioned along the side safety panels 22 of the base frame 12. Exemplary side barriers include side rails and other exemplary members to prevent egress of a patient.

An occupant support surface 30 is supported on the base frame 12. As shown in FIG. 1, the occupant support surface 30 is positioned between the side barriers 28 and the side barriers 30 and between the footboard 24 and the headboard 26. A fluid supply control unit 90 is also supported by base frame 12. The fluid supply control unit 90 interacts with one or more components of the occupant support surface 30 through an interface 32. The fluid supply control unit 90 may be separated from the occupant support surface 30.

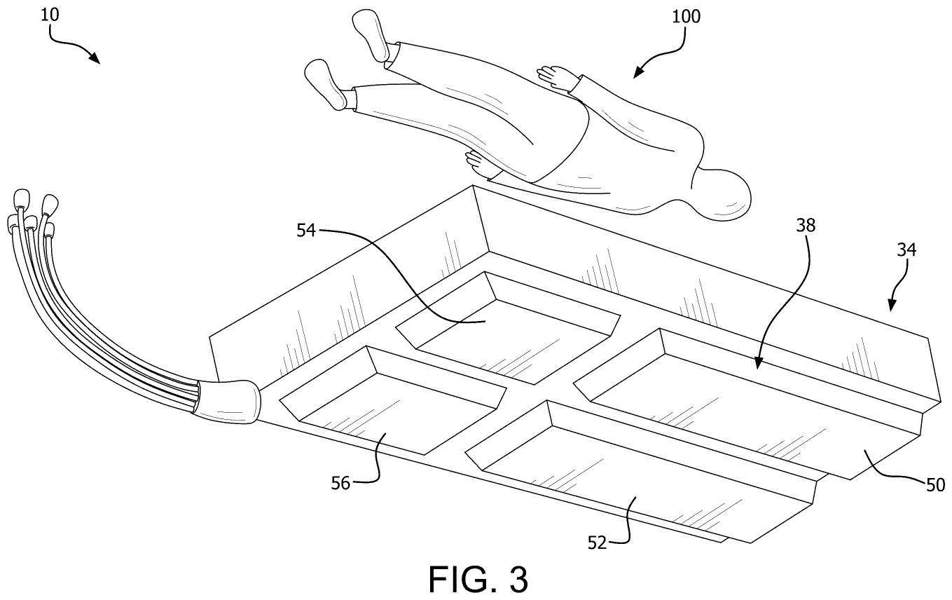

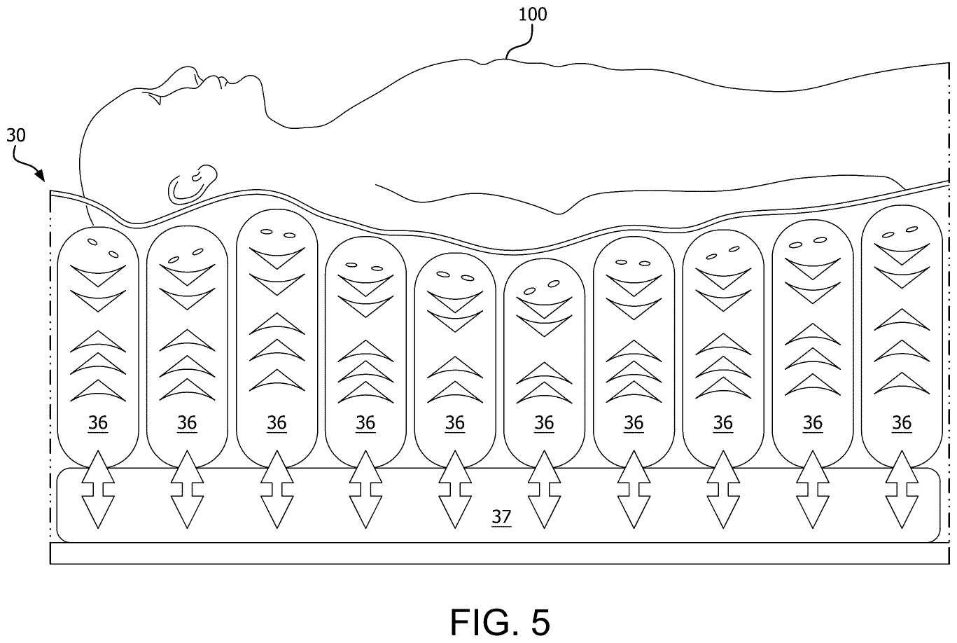

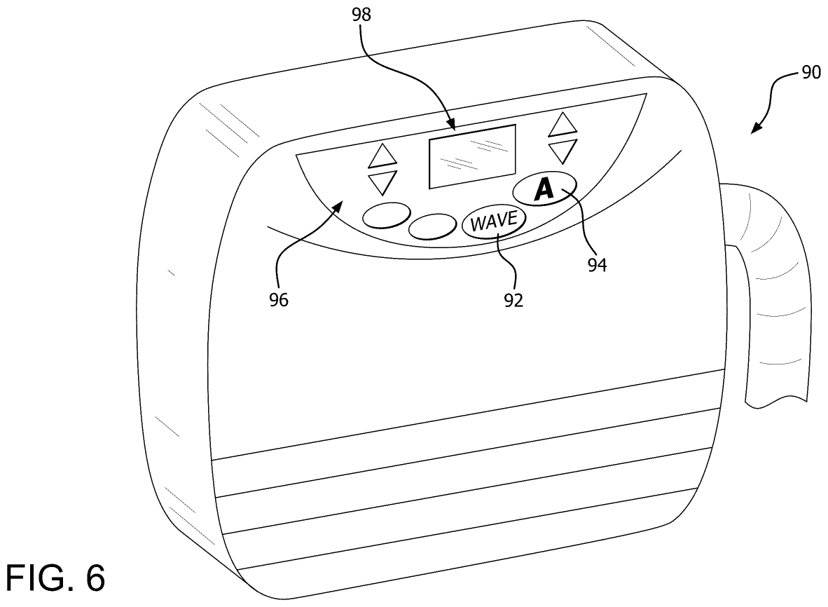

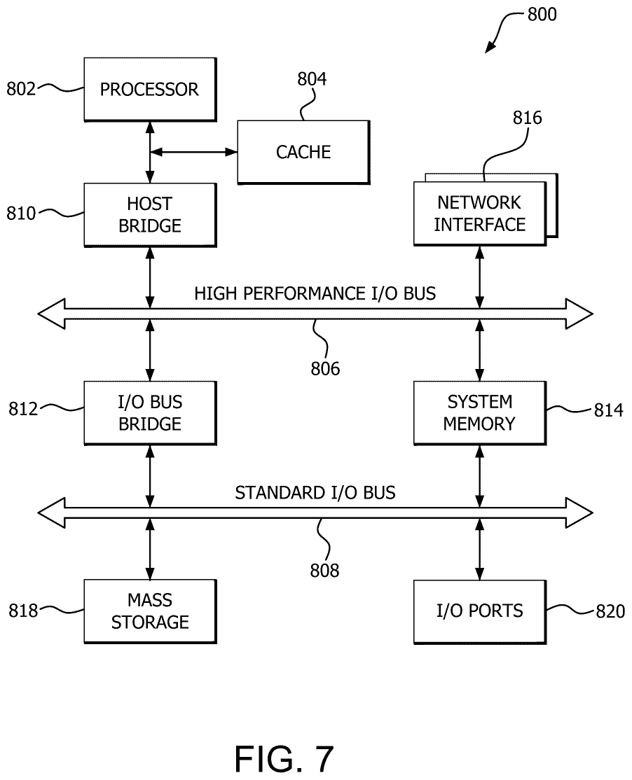

As shown in FIG. 2, the occupant support surface 30 includes a base support surface 34 having a plenum 37 (see FIGS. 5 and 6), a plurality of body bladders 36, a plurality of turn bladders 38, and a pair of turn bladder covers 40 that are attached to the base support surface 34 with a fastener 42, such as a zipper, a hook and loop fastener, or other suitable form of attachment. For example, certain of the bladders can be alternated between inflated and deflated states for applying a wave therapy in accordance with the present invention as described in more detail below.

The turn bladders 39 are inflated and deflated depending on the needs of the occupant, patient, caregiver, and/or the base support surface 34. For example, certain of the bladders 38 can be alternated between inflated and deflated states to alternatively turn an occupant on their right or left sides for alternating rotation therapy. To assist a caregiver in turning a patient, the right side or left side bladder may be inflated as the respective left side or right side bladders are deflated to partial turn a patient over. To facilitate the use of base support surface 34 for use on a base frame 12 having a recessed deck, the turn bladders 38 may be inflated to raise base support surface 34. To facilitate the use of base support surface 34 for use in a base frame 12 with a flat deck, the bladders 38 may remain deflated during normal use so that the base support surface 34 is not raised.

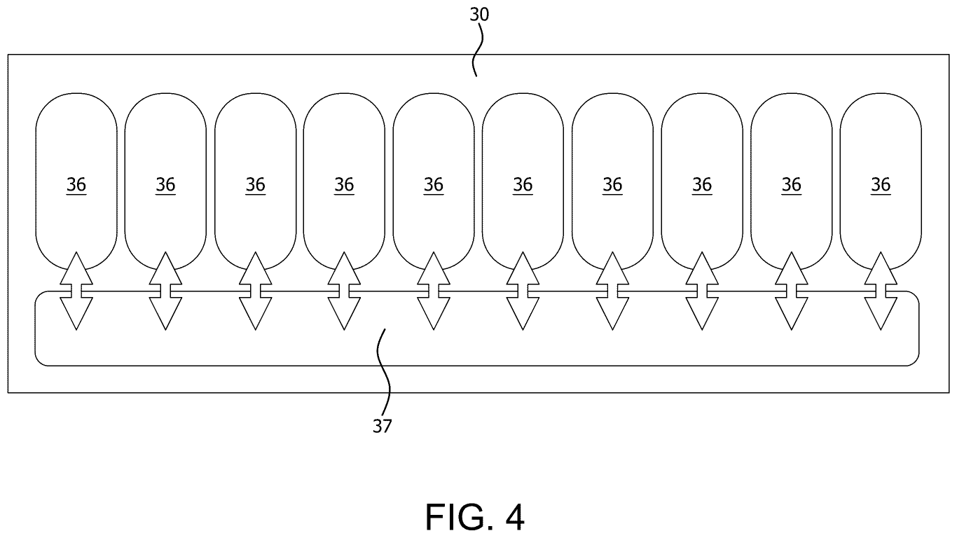

As best seen in FIGS. 1-3. The occupant support 10 includes a turn valve assembly 44 that controls the inflation and deflation of the turn bladders 38, a body valve 46 that controls the inflation and deflation of the body bladders 36 positioned under the occupant 100, and a plurality of tubes 48 that connect valve assembly 44 to an air pump 80 of the fluid supply control unit 90 and turn bladders 38. The plurality of turn bladders 38 includes a right torso turn bladder 50, a left torso turn bladder 52, a right foot bladder 54, and a left foot bladder 56. The right and left torso turn bladders 50, 52 preferably include a plurality of longitudinally extending gussets to control the inflated height thereof. Similarly, the right and left foot bladders 54, 56 preferably include a plurality of laterally extending gussets to control the inflated height thereof.

The plurality of tubes 48 includes right torso tube 58 extending between the valve assembly 44 and the right torso turn bladder 50, the left torso tube 54 extends between the valve assembly 44 and the left torso turn bladder 52, the right and left foot tubes 72 extending between valve assembly 44 and right and left foot bladders 54, 56, and air pump tube 74 extending between the air pump 80 and the valve assembly 44. The air pump 80 also provides pressurized air to the occupant support surface 30 through support surface tubes 76.

The body valve assembly 46 controls the egress of air from the body bladders 36 and plenum 37 positioned under the patient. The body valve assembly 46 is positioned behind a flap 62 formed in cover 64 so that the valve assembly 44 is accessible by lifting the flap 62.

The base occupant support surface 34 exhibits enough flexibility to conform to the profile defined by the orientation adjustable deck sections. Various occupant support surface constructions may be used. These include but are not limited to occupant support surface that employ foam, inflatable bladders, or a combination of foam and inflatable bladders or chambers.

Referring now to FIG. 6, the fluid supply control unit 90 is programmed to control the inflation and deflation as the body bladders 36. The fluid supply control unit 90 includes various controls 96 and a display 98. The fluid supply control unit 90 also includes an auto set control 94 and a wave therapy control 96 to effect the methods of the present invention which relate to a method of inflating and deflating the body bladders 36 to provide a wave therapy method.

Referring to FIGS. 5 and 6, wave therapy has an “extended low pressure duration” (pressure cycle time) unlike works similar “pulsation” therapy applications, however wave therapy is considered to have, and in operation holds a specific pressure, based on the weight of the occupant 100 on the base support surface 30, for a preferred period of ninety (90) seconds. During this period, the pressure is continuously adjusting amongst each bladder 36; as the chambers of each bladder 36 are centrally connected without restriction to the pressurized plenum 37. This low pressure allows the surface occupant 100 (patient) to immerse into the surface, (FIG. 5) which provides a greater skin contact area, thus further redistributing the occupants weight, and relieving pressure. At the end of the ninety (90) second low period, the control unit increases the pressure in the plenum by 20%, and holds this new pressure for a duration of sixty (60) seconds. At the end of the sixty (60) second period, the control unit decreases pressure again by 20% returning the occupant support surface to the original set low pressure. This cycle continually repeats until a different mode is selected.

Alternatively, manually setting the unit to perform the WAVE function via control 92, the user has the choice to select “auto set” functionality via control 94. The auto set functionality is a menu of pre-programmed set of parameters, preferably at least two, which are appropriate for two distinct ranges of occupants. The range selected; “Standard” or “Bariatric,” determines the amount of pressure delivered during Wave therapy. Auto set “standard” delivers pressures from about 17 mmHg (low pressure duration) to about 22 mmHg (high pressure duration). Auto set “Bariatric” delivers pressures from about 24 mmHg (low pressure duration) to about 30 mmHg (high pressure duration). Selecting the Auto set functionality maintains the same time interval as manually programming Wave therapy for the height and weight of the occupant.

FIG. 7 illustrates an example computing system architecture, which may be used to implement a server 822 or a client system 830 to implement the wave therapy methods of the present invention. In one embodiment, the fluid supply control unit 90 includes hardware system 800 comprises a processor 802, a cache memory 804, and one or more executable modules and drivers, stored on a tangible computer readable medium, directed to the functions described herein. Additionally, hardware system 800 may include a high performance input/output (I/O) bus 806 and a standard I/O bus 808. A host bridge 810 may couple processor 802 to high performance I/O bus 806, whereas I/O bus bridge 812 couples the two buses 806 and 808 to each other. A system memory 814 and one or more network/communication interfaces 816 may couple to bus 806. Hardware system 800 may further include video memory (not shown) and a display device coupled to the video memory. Mass storage 818 and I/O ports 820 may couple to bus 808. Hardware system 800 may optionally include a keyboard, a pointing device, and a display device (not shown) coupled to bus 708. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 800 are described in greater detail below. In particular, network interface 816 provides communication between hardware system 800 and any of a wide range of networks, such as an Ethernet (e.g., IEEE 802.3) network, a backplane, and the like. Mass storage 818 provides permanent storage for the data and programming instructions to perform the above-described functions implemented in servers 822, whereas system memory 814 (e.g., DRAM) provides temporary storage for the data and programming instructions when executed by processor 802. I/O ports 820 are one or more serial and/or parallel communication ports that provide communication between additional peripheral devices, which may be coupled to hardware system 800.

Hardware system 800 may include a variety of system architectures and various components of hardware system 800 may be rearranged. For example, cache 804 may be on-chip with processor 802. Alternatively, cache 804 and processor 802 may be packed together as a “processor module,” with processor 802 being referred to as the “processor core.” Furthermore, certain embodiments of the present disclosure may not require nor include all of the above components. For example, the peripheral devices shown coupled to standard I/O bus 808 may couple to high performance I/O bus 806. In addition, in some embodiments, only a single bus may exist, with the components of hardware system 800 being coupled to the single bus. Furthermore, hardware system 800 may include additional components, such as additional processors, storage devices, or memories.

An operating system manages and controls the operation of hardware system 800, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft.RTM. Windows.RTM. operating systems, BSD operating systems, and the like. Of course, other embodiments are possible. For example, the functions described herein may be implemented in firmware or on an application-specific integrated circuit.

Furthermore, the above-described elements and operations can be comprised of instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions are operational when executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

Certain embodiments are described herein may include or be embodied in logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).

One or more features from any embodiment may be combined with one or more features of any other embodiment without departing from the scope of the disclosure. A recitation of “a,” “an,” or “the” is intended to mean “one or more” unless specifically indicated to the contrary.

The present disclosure encompasses all changes, substitutions, variations, alterations, and modifications to the example embodiments herein that a person having ordinary skill in the art would comprehend. For example, the methods, application features and application mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, personal digital assistance, personal gaming device, and the like), that makes API calls directly to a server. The specification and drawings are, accordingly, to be regarded in an illustrative rather than a restrictive sense. It will, however, be evident that various modifications and changes may be made thereunto without departing from the broader spirit and scope of the disclosure.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for applying wave therapy to an occupant surface comprising:
an occupant surface for accepting an occupant thereon;
a fluid supply control unit for setting a first pressure, based on physical characteristics of the occupant of the surface, for a preferred first preselected duration; and
continuously adjusting the pressure applied.

2. The wave therapy method according to claim 1 wherein continuously adjusting the pressure comprises increasing the pressure by a preselected amount and holding this second pressure for a second preselected duration.

3. The wave therapy method according to claim 2 wherein continuously adjusting the pressure further comprises decreasing the pressure by the preselected amount to return the surface to the first set low pressure.

4. The wave therapy method according to claim 3 repeating the cycle repeats one or more times.

5. The wave therapy method according to claim 4 wherein the first preselected duration is about 90 seconds and the cycle one or more times, the preselected amount of pressure is 20%, and the second preselected duration is about 60 seconds.

6. The wave therapy method according to claim 4 wherein the occupant surface comprises a pressurized plenum having a plurality of connected bladders.

7. The wave therapy method according to claim 3 further comprising an auto set functionality that delivers pressures from about 17 mmHg (low pressure duration) to about 22 mmHg (high pressure duration).

8. The wave therapy method according to claim 3 further comprising an auto set functionality that delivers pressures from about from about 24 mmHg (low pressure duration) to about 30 mmHg (high pressure duration).

9. An occupant platform comprising:
an occupant surface for accepting an occupant thereon;
a fluid supply control unit for holding a first pressure, based on the weight of the occupant of the surface, for a preferred first preselected duration; and
continuously adjusting the pressure applied.

10. The occupant platform according to claim 9 wherein continuously adjusting the pressure further comprises decreasing the pressure by the preselected amount to return the surface to the original set first pressure.

11. The occupant platform according to claim 10 repeating the cycle repeats one or more times.

12. The occupant platform according to claim 11 wherein the first preselected duration is about 90 seconds and the cycle one or more times, the preselected amount of pressure is 20%, and the second preselected duration is about 60 seconds.

13. The occupant platform according to claim 12 wherein the occupant surface comprises a pressurized plenum having a plurality of connected bladders or cells.

14. The wave therapy method according to claim 11 further comprising an auto set functionality that delivers pressures from about 17 mmHg (low pressure duration) to about 22 mmHg (high pressure duration).

15. The wave therapy method according to claim 11 further comprising an auto set functionality that delivers pressures from about from about 24 mmHg (low pressure duration) to about 30 mmHg (high pressure duration).
